(19) United States
(12) Patent Application Publication
(10) Pub. No.: US 2025/0301451 A1
(43) Pub. Date: Sep. 25, 2025

(54) ENABLING INCUMBENT-SAFE USE OF WIRELESS TECHNOLOGIES IN MOBILE APPLICATIONS

(71) Applicant: Cisco Technology, Inc., San Jose, CA (US)

(72) Inventors: Nedime Pelin MOHAMED HASSAN SALEM, San Jose, CA (US); John M. SWARTZ, Lithia, FL (US); Jerome HENRY, Pittsboro, NC (US); William H. DAVENPORT, McLean, VA (US); Brian D. HART, Sunnyvale, CA (US)

(21) Appl. No.: 19/090,360

(22) Filed: Mar. 25, 2025

Related U.S. Application Data
(60) Provisional application No. 63/569,610, filed on Mar. 25, 2024.

(51) Int. Cl. H04W 72/02; H04B 17/318; H04W 72/0453; H04W 72/51; H04W 72/541

(52) U.S. Cl. CPC H04W 72/02; H04B 17/318; H04W 72/0453; H04W 72/51; H04W 72/541

(57) ABSTRACT

Techniques for expanding transmission capabilities across frequency bands. The techniques include receiving, at an access point, a request from a client device to transmit via a particular wireless frequency band. The techniques further include detecting, using the access point, that one or more devices are transmitting via the particular wireless frequency band, wherein the detecting comprises sensing a certain waveform associated with the particular wireless frequency band and having a signal strength above a threshold value. The techniques further include selecting a wireless frequency band of the access point based on the detecting to avoid interfering with the one or more devices. The techniques further include communicating with the client device via the selected wireless frequency band.

### CROSS-REFERENCE TO RELATED APPLICATIONS

This application claims benefit of co-pending U.S. provisional patent application Ser. No. 63/569,610 filed Mar. 25, 2024. The aforementioned related patent application is herein incorporated by reference in its entirety.

### TECHNICAL FIELD

Embodiments presented in this disclosure generally relate to wireless communications. More specifically, embodiments disclosed herein relate to expanding transmission capabilities across frequency bands.

### BACKGROUND

Devices, such as mobile phones, tablets, laptop computers, etc., are becoming increasingly more capable, integrated with a variety of functions which may include Bluetooth, Wi-Fi, and LTE capabilities. More specifically, these devices may be able to connect to Wi-Fi services (e.g., via an access point) on multiple frequency bands, including 2.4 GHz, 5 GHz, and/or 6 GHz. The Federal Communications Commission (FCC) rules currently prohibit access points from providing Wi-Fi over certain frequency bands for use in mobile applications (such as on boats, cars, trains, certain aircraft, etc.) due to concerns of potential interference with critical infrastructure, such as sensitive weather detection equipment and satellite services. In many cases, however, it is desirable to implement Wi-Fi over these certain frequency bands which may result in faster speeds, increased device capacity, better coverage, and enhanced security. Current techniques do not adequately address avenues for feasible cooperation between these two competing interests.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example access point (AP) and one or more connected devices with Wi-Fi capabilities, according to some embodiments of the present disclosure.

FIG. 2 depicts an example interaction in which an associated AP communicates with a connected station (STA) via one or more selected frequency bands, according to some embodiments of the present disclosure.

FIG. 3 is a flow diagram for detecting incumbents and adjusting operations prior to servicing the connected STA, according to some embodiments of the present disclosure.

FIG. 4 is a flow diagram for detecting incumbents and adjusting operations prior to servicing the connected STA, according to some embodiments of the present disclosure.

FIG. 5 is a flow diagram depicting an example method 500 for expanding transmission capabilities across frequency bands, according to some embodiments of the present disclosure.

FIG. 6 depicts an example network device 600 configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments described herein include a method. The method includes receiving, at an access point, a request from a client device to transmit via a particular wireless frequency band. The method further includes detecting, using the access point, that one or more devices are transmitting via the particular wireless frequency band, wherein the detecting comprises sensing a signal having an associated signal strength above a threshold value. The method further includes selecting a wireless frequency band of the access point based on the detecting to avoid interfering with the one or more devices. The method further includes communicating with the client device via the selected wireless frequency band receiving a plurality of absence signals from a wireless device.

Embodiments further include a system, including one or more processors and one or more memories storing a program, which, when executed on any combination of the one or more processors, performs operations. The operations include receiving, at an access point, a request from a client device to transmit via a particular wireless frequency band. The operations further include detecting, using the access point, that one or more devices are transmitting via the particular wireless frequency band, wherein the detecting comprises sensing a signal having an associated signal strength above a threshold value. The operations further include selecting a wireless frequency band of the access point based on the detecting to avoid interfering with the one or more devices. The operations further include communicating with the client device via the selected wireless frequency band receiving a plurality of absence signals from a wireless device.

Embodiments further include a non-transitory computer-readable medium containing computer program code that, when executed by operation of one or more computer processors, performs operations. The operations include receiving, at an access point, a request from a client device to transmit via a particular wireless frequency band. The operations further include detecting, using the access point, that one or more devices are transmitting via the particular wireless frequency band, wherein the detecting comprises sensing a signal having an associated signal strength above a threshold value. The operations further include selecting a wireless frequency band of the access point based on the detecting to avoid interfering with the one or more devices. The operations further include communicating with the client device via the selected wireless frequency band receiving a plurality of absence signals from a wireless device.

### EXAMPLE EMBODIMENTS

Aspects of the present disclosure provide apparatuses, methods, processing systems, and computer-readable mediums for expanding transmission capabilities across frequency bands.

Nowadays, many devices (e.g., smartphones, laptops, etc.) may connect to Wi-Fi on a number of frequency bands, including 2.4 GHz, 5 GHz, and/or 6 GHz. The particular frequency band by which a device connects to Wi-Fi may depend on several factors, such as desired range, connectivity speed, other connected devices, and/or the like. In certain situations, however, an access point may be prevented from broadcasting a particular frequency band (such as by regulation). For example, the FCC prevents 6 GHz Wi-Fi in mobile applications, such as on boats, to limit interference with infrastructure like weather measurement systems in the ocean. This results in less than optimal performance for connected devices (e.g., reduced speeds), more wireless congestion on other frequency bands, and/or a diminished user experience.

To improve wireless traffic management, techniques described herein utilize an AP to detect incumbent activity on a particular frequency band and automatically adjust operations of the AP accordingly.

For example, a client device, such as a smartphone, may send a request to an AP to connect to Wi-Fi. The preferred frequency band for the Wi-Fi connection, for instance, may be 6 GHz (i.e., if both the client device and the AP support 6 GHz Wi-Fi). In some cases, the AP may seek to broadcast Wi-Fi over a particular frequency band without receiving a request from a client device (such as by default setting). The AP may then detect whether one or more incumbents (i.e., existing users, licensed services, and/or the like) are currently operating on the particular frequency band. The AP may detect incumbents by sensing for a signal having a signal strength greater than a threshold value (e.g., by performing clear channel assessment (CCA)). If the AP detects a signal with a signal strength over the threshold value, one or more channels may be busy (i.e., incumbents are transmitting via the particular wireless frequency band). In one example, the threshold value may be set to −62 dBm when sensing for activity on the 6 GHz frequency band.

Based on the detecting, the AP may select a frequency band by which to operate and/or adjust one or more other settings. In some cases, if one or more incumbents are detected, the AP may not use that particular frequency band until the incumbent(s) are no longer detected (e.g., switch to 5 GHz operations until 6 GHz is available). For example, the AP may intermittently perform the detection process so to determine when the particular frequency band is clear of incumbents. Alternatively, the AP may operate at the particular frequency band but only on a portion of the frequency band that is not in use by incumbents (e.g., through channel puncturing). In this way, the AP can still operate at the preferred frequency band without causing interference with the incumbent(s). Additionally, the AP may operate at the particular frequency band but at reduced power. This also allows nearby client devices serviced by the AP to remain connected via the particular frequency band without interfering with incumbents. If, however, the AP determines it is clear to transmit via the particular frequency band (e.g., 6 GHz), it may begin and continue to operate on the particular frequency band until that frequency band is again determined to be busy (e.g., by one of the aforementioned detection processes), in which case it may readjust its operations to avoid interfering with incumbents. Once the AP selects the frequency band, it may communicate with the connected client devices using that frequency band.

In some cases, such as during the detection process, the AP may utilize a cloud-based system to record and classify nearby transmissions according to their features. For example, if the transmission belongs to a weather sensor which must operate on the 6 GHz frequency band without interference, the AP is informed that the frequency band is in use. The AP may then adjust accordingly as described above.

In some cases, the AP may select the frequency band based on a location of the AP. For example, if the AP is mobile (e.g., on a ship), it may pass by potential incumbents (which may be stationary or moving). Based on the AP's distance from a known incumbent (e.g., a piece of weather sensing equipment in the ocean) or a region of unsupported and/or prohibited operations (e.g., a coastline), the AP may adjust its operations. For example, if an AP on a ship is more than threshold distance from a particular country or weather sensor, it may operate via the particular frequency band (e.g., 6 GHz). Once the AP moves to a position that is less than the threshold distance, the AP may adjust accordingly (e.g., switch frequency bands, reduce power, etc. as described above). In other cases, when the future positions of the AP are known (such as based on a planned travel route), the AP can be programmed in advance to adjust operations as it travels along the route.

These techniques optimize operations for client devices and APs as they are able to communicate via a preferred frequency band for extended periods of time, adjusting once incumbents are detected (i.e., rather than disabling operations entirely), which may be done automatically and/or in advance.

As referenced throughout the present disclosure, the 6 GHz frequency band generally refers to a frequency band encompassing frequencies from 5.925 GHz to 7.125 GHz. The present disclosure is not limited to the 6 GHz frequency band (and by extension the frequencies therein) but may include frequencies and/or frequency bands other than 6 GHz.

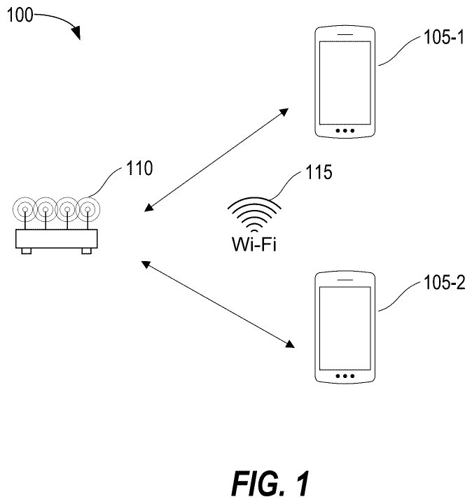

FIG. 1 depicts an example AP and one or more connected devices with Wi-Fi capabilities, according to some embodiments of the present disclosure.

As depicted, STA 105-1 and/or STA 105-2 connects to AP 110 as a client in a basic service set (BSS). Through this wireless connection 115 (e.g., a Wi-Fi connection), STAs 105-1 and 105-2 gain access to the broader network infrastructure (e.g., Internet). This connection follows Wi-Fi infrastructure mode, where AP 110 manages the communication between STAs and other devices on the network and coordinates transmission timing and resource allocation. Embodiments described herein may apply to any wireless protocol that has frequency bands with incumbents.

In this figure, STAs 105-1 and 105-2 are depicted as mobile phones, which is provided for conceptual clarity. In some embodiments, STAs 105-1 and 105-2 may be any other wireless communication devices, such as laptops, tablets, smartwatches, any other portable or stationary devices configured with wireless communication technologies, or a combination thereof. In certain embodiments, there may be additional devices or fewer devices connected to AP 110 than depicted in this figure.

The depicted wireless technologies, including Wi-Fi for infrastructure connections 115, are provided as examples for conceptual clarity. In some embodiments, STAs 105-1 and/or 105-2 may support additional wireless communication interfaces, including Bluetooth (used for low-power, short-range data exchange, such as audio streaming, peripheral device pairing, or file transfers), Ultra-Wideband (used for high-precision spatial awareness and data synchronization, such as indoor positioning, secure keyless access, or high-speed data transfer between devices), Wi-Fi Direct (used for high-speed and medium-range data transfer, such as sharing large files or streaming high-quality media between devices), Wi-Fi for off-channel docking (used for wireless display mirroring, data transfer, or peripheral connections to a docking station) or Near Field Communication (NFC) (for short-range authentication and data exchange).

In some embodiments, STAs 105-1 and/or 105-2 may utilize a multi-link operation (MLO) setup, where the devices maintain simultaneous connections to AP 110 over multiple frequency bands. For example, STA 105-1 may establish three concurrent links with AP 110, including one link on the 2.4 GHz band (for longer range and lower power consumption), one link on the 5 GHz band (for higher throughput and reduced interference), and one link on 6 GHz band (for ultra-fast and low-latency communication).

In order to limit interference (e.g., with other devices) while also enabling Wi-Fi connectivity across multiple frequency bands, the AP 110 may scan and/or predict incumbents operating via one or more of the aforementioned frequency bands and automatically adjust its operations accordingly (e.g., by switching frequency bands, reducing power, and/or the like). Further details about detecting incumbents and adjusting operations are discussed below.

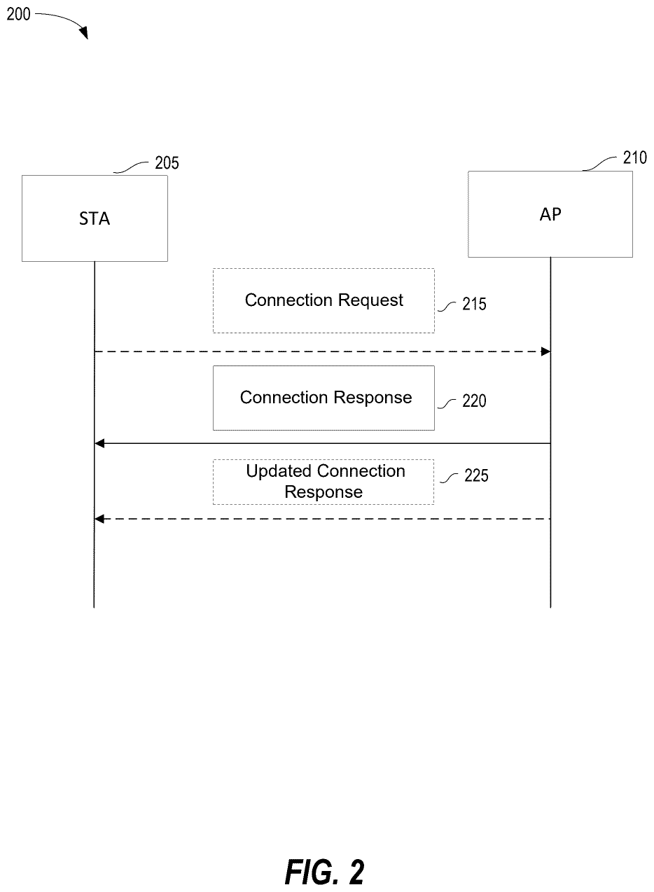

FIG. 2 depicts an example interaction in which an associated AP communicates with a connected STA via one or more selected frequency bands, according to some embodiments of the present disclosure.

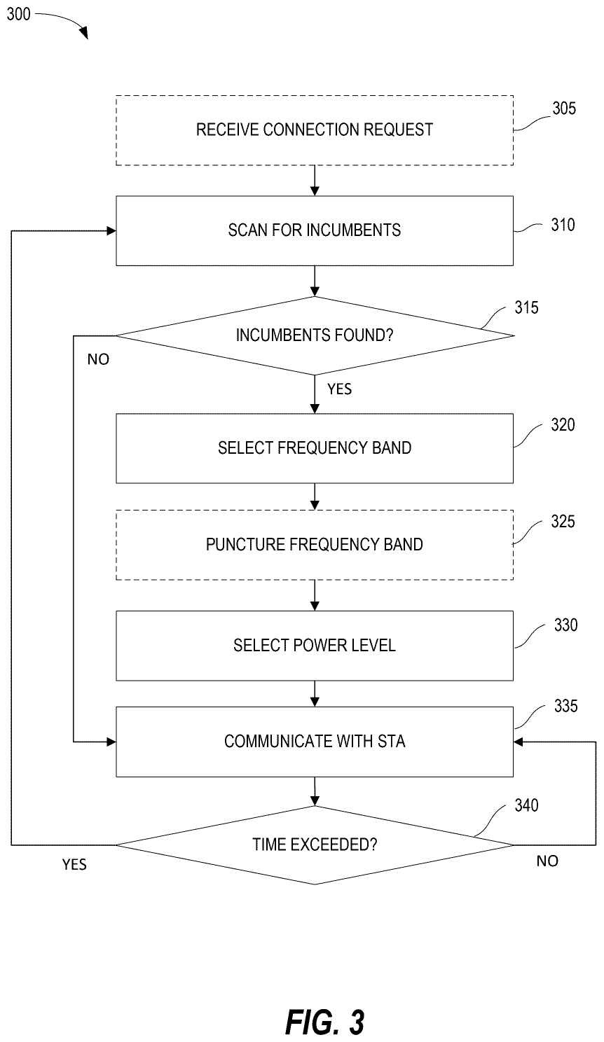

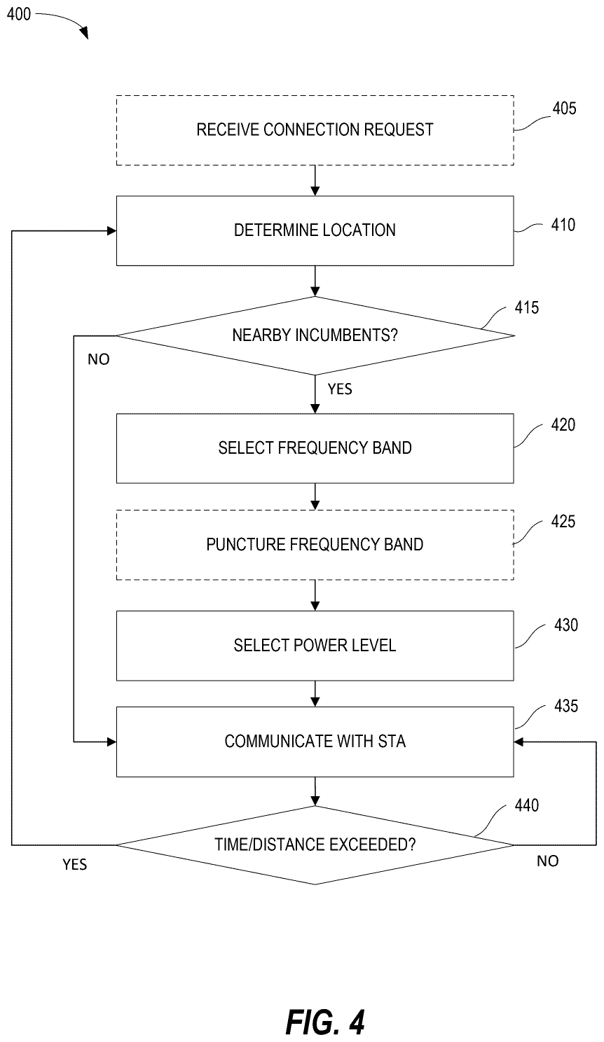

As depicted, the STA 205 may send a connection request 215 to the AP 210. The STA 205 may be associated with the AP 210, and may integrate multiple wireless technologies (e.g., Wi-Fi, Bluetooth, Ultra-Wideband) in shared hardware resources. For example, STA 205 may be a smartphone attempting to connect to Wi-Fi services provided by the AP 210. The connection request 215 may also include a specific frequency band by which the STA 205 wishes to connect to Wi-Fi. In some embodiments, the AP 210 may broadcast Wi-Fi signals without first receiving a specific request from a particular STA. In either case, before the AP begins broadcasting Wi-Fi over a particular frequency band (e.g., a preferred and/or default frequency band), it may determine whether there are incumbents (i.e., other users) occupying some or all of the frequency band (e.g., to avoid interference with incumbents which may impede wireless traffic and/or be prohibited). Based on the determination, the AP 210 may adjust various settings, such as choosing a frequency band, a subset of the frequency band, and/or a power level with which to transmit. The AP 210 may send a connection response 220 to the STA 205 and/or may begin transmitting according to the selected settings. For example, if no incumbents were detected on the 6 GHz frequency band, the AP 210 may provide Wi-Fi via that frequency band, while if incumbents were detected, the AP 210 may transmit via the 5 GHz frequency band or transmit via the 6 GHz frequency band but at reduced power (i.e., so as to not cause interference). If, at a later time, there is a change in the state of the particular frequency band (e.g., incumbents are now detected or are no longer detected), the AP 210 may send an updated connection response 225 and/or adjust operations to account for the changes (such as switching to the particular frequency band or to another frequency band and/or change its power level). While STA 205 is connected to AP 210, this process may be performed a number of times, such as based on a time or a location of the AP. Further details about the detection and adjustment processes are described in more detail with respect to FIGS. 3 and 4.

FIG. 3 depicts an example method for the associated AP to detect incumbents and adjust operations prior to servicing the connected STA, according to some embodiments of the present disclosure. In some embodiments, the method 300 may be performed by one or more network devices, such as AP 110 as depicted in FIG. 1 and AP 210 as depicted in FIG. 2.

At block 305, an AP (e.g., AP 110 of FIG. 1 or AP 210 of FIG. 2), receives a connection request (e.g., connection request 215 of FIG. 2) from an STA (e.g., STA 105-1 in FIG. 1 or STA 205 of FIG. 2). For example, the STA may be a smartphone attempting to connect to Wi-Fi services provided by the AP. The connection request may also include a specific frequency band by which the STA wishes to connect to Wi-Fi (e.g., via a 6 GHz frequency band). In some embodiments, the AP may broadcast Wi-Fi signals without first receiving a specific request from a particular STA (e.g., the AP, such as a router, regularly provides Wi-Fi to a number of STAs in the vicinity). The AP may have a particular frequency band over which it seeks to operate (either requested by the STA or chosen by the AP such as by a default setting).

At block 310, the AP initiates an incumbent detection process. Incumbents may include existing users, licensed services, wireless devices, and/or the like that are operating on the particular frequency band. The AP may use CCA and/or a received signal strength indicator (RSSI) to detect any incumbents on the particular frequency band over which it seeks to operate. CCA refers to a process by which an AP assesses the strength of a received signal to determine if the frequency band (or a subset thereof) is busy (i.e., there are incumbents present). RSSI refers to a measure of the power level of a received wireless signal. In general, RSSI may be expressed in decibels relative to a milliwatt (dBm), with values ranging from 0 (indicative of the strongest signal) to approximately −100 dBm (indicative of a very weak signal). If the AP senses a signal having a signal strength above a designated threshold, it may determine that an incumbent is present. For example, to sense incumbents on the 6 GHz frequency band, the AP may scan for signals with a signal strength equal to or above −62 dBm. In one embodiment, any signal detected at or above that level indicates that there are incumbents operating via 6 GHz nearby.

In some embodiments, the AP detects incumbents by performing centralized crowdsourcing. For example, the AP may record transmissions and associated automatic frequency coordination (AFC) responses and send them to the cloud (e.g., a network of servers and software accessed over the internet, enabling users to access and store data and applications remotely). There, the responses are correlated with the transmission and a signature is identified for one or more incumbents. That information is then passed back to the AP. In one embodiment, an AFC system is a cloud-based operator that has access to the FCC's 6 GHz incumbent database, which stores geolocation coordinates and power ratings of licensed wireless services operating in the 6 GHz spectrum. In order to avoid interference among incumbents, an AP presents its geolocation coordinates to the AFC provider when powering on and before powering on the 6 GHz radio. Upon receiving a request for location information, the AFC provider will query its database to see if there is an overlap of a licensed 6 GHz service in that location. Based on its computed results, the AFC will send a response with the channels and the power levels at which the AP can operate. So, in this case, the AP is told of incumbents that are nearby and that are operating at a particular frequency band (e.g., 6 GHz).

At block 315, the AP determines, either from the sensing or from the crowdsourcing, whether incumbents are present on the particular frequency band. If no incumbents are present, the AP is free to operate via the particular frequency band and the method 300 proceeds directly to block 335. If, however, there are incumbents present on the particular frequency band, the method 300 moves to block 320.

At block 320, the AP selects a frequency band by which to operate (e.g., provide Wi-Fi to the one or more connected STAs). In some embodiments, the AP may operate via a frequency band different than the particular frequency band. For example, if there are incumbents on the 6 GHz frequency band, the AP can switch to a 5 GHz frequency band (e.g., for providing Wi-Fi to the STA). In other embodiments, the AP may elect to operate via the particular frequency band (even though incumbents are present) by puncturing the frequency band, as described at block 325. In certain other embodiments, the AP may elect to operate via the particular frequency band (even though incumbents are present) by reducing a power level of the AP as described at block 330.

At block 325, the AP may puncture the particular frequency band (i.e., if the AP selected to operate at the particular frequency band). Puncturing, or preamble puncturing, may refer to a technique where a portion of channel bandwidth is reserved to avoid interference, allowing the remaining spectrum to be used for data transmission. For example, if a certain frequency band encompasses 1200 MHz and consists of 59 channels (e.g., 20 MHz each), an incumbent may only be occupying a portion of that frequency band (e.g., 160 MHz). By puncturing, an AP, for instance, may operate on the remaining channels of the particular frequency band without interfering with the incumbent (and without having to switch frequency bands).

At block 330, the AP determines a power level at which to operate. If, for instance, the AP switches frequency bands (e.g., from 6 GHz to 5 GHz) or punctures the particular frequency band, the AP may operate at standard power (e.g., a full power mode with the longest range), which can be utilized in many indoor and/or outdoor applications. In some embodiments, the AP may select the particular frequency band even though incumbents are present and will not or cannot puncture that frequency band. In that case, to avoid interference with the incumbents, the AP may operate in a low power mode. For example, reducing the power of an AP that is indoors prevents any transmissions from being strong enough to escape (i.e., from a structure) and no interference occurs, while still allowing for connected STAs to benefit from using the particular frequency band.

At block 335, the AP commences operations according to the previous steps and/or communicate with the connected STA. The AP may continue operations at block 335 until a certain period has passed. After the certain period of time (e.g., a time designated by regulation, determined by the AP, and/or the like) has passed, the AP may return to block 310 to restart the process. For example, there may no longer be an incumbent operating at the particular frequency band and the AP may begin operations on that frequency band. Alternatively, there may now be an incumbent that was not present before and the AP may adjust accordingly (e.g., switch frequency bands, reduce power, etc.). In this way, the AP is continuously maximizing operations at a desired frequency band while avoiding interference with incumbents.

FIG. 4 depicts an additional example method for the associated AP to detect incumbents and adjust operations prior to servicing the connected STA, according to some embodiments of the present disclosure. In some embodiments, the method 400 may be performed by one or more network devices, such as AP 110 as depicted in FIG. 1 and AP 210 as depicted in FIG. 2.

At block 405, like at block 305 of FIG. 3, an AP (e.g., AP 110 of FIG. 1 or AP 210 of FIG. 2), receives a connection request (e.g., connection request 215 of FIG. 2) from an STA (e.g., STA 105-1 in FIG. 1 or STA 205 of FIG. 2). For example, the STA may be a smartphone attempting to connect to Wi-Fi services provided by the AP. The connection request may also include a specific frequency band by which the STA wishes to connect to Wi-Fi (e.g., via a 6 GHz frequency band). In some embodiments, the AP may broadcast Wi-Fi signals without first receiving a specific request from a particular STA (e.g., the AP, such as a router, regularly provides Wi-Fi to a number of STAs in the vicinity). The AP may have a particular frequency band over which it seeks to operate (either requested by the STA or chosen by the AP such as by a default setting).

At block 410, the AP determines a location of the AP and/or locations of nearby incumbents operating on the particular frequency band. In some embodiments, the AP may be used in a mobile application, such as mounted on a vehicle. A vehicle may include, but is not limited to a ship (or other types of vessels) car, bus, plane, train and/or the like. For example, a mobile AP (e.g., on a ship) may sense the ship's latitude-longitude coordinates, such as through an onboard global navigation satellite system (GNSS) receiver or through assisted sensing (working with nearby APs with geolocation information or from nearby cell towers and/or other satellite services). The AP may determine nearby incumbents (e.g., offshore weather equipment, critical pieces of infrastructure, etc.) by using sensing or crowdsourcing methods such as those described with respect to FIG. 3, while the AP may determine certain regions with limited and/or restricted 6 GHz availability (e.g., a country, outpost, etc. with substantial 6 GHz activity that would result in interference) from known and documented geographic and telecommunication information.

In some embodiments, the aforementioned locations may be determined prior to mobile deployment of the AP (i.e., before a trip). Since many travel routes, such as a sailing path, flight path, etc., are known prior to departure, the AP may determine its future coordinates ahead of time. The AP may also determine incumbents ahead of time, such as by sending an AFC request with a batch of coordinates. The AFC system may then respond with corresponding channel assignments (i.e., based on known incumbents) for each provided coordinate.

The AP then adjusts and commences operations at one or more of blocks 420, 425, 430, and 435 based on a distance between one or more of the determined locations. In some embodiments, the AP may determine and/or be provided a threshold distance. The threshold distance may vary based on a relative vicinity of the AP. For example, the threshold distance may increase if a ship is traveling in (or a plane traveling over) open, international waters, and/or near a country with no 6 GHz support (since there will be a lower risk of interference when there are few or no 6 GHz capable incumbents). If the location of the AP is more than the threshold distance (including a distance between two locations and/or an altitude over a location) from an incumbent (e.g., equipment, coastline, etc.), then the AP is free to operate via the particular frequency band (e.g., provide 6 GHz Wi-Fi to connected STAs). If the location of the AP is less than the threshold distance from an incumbent, then the AP may adjust its operations accordingly. For example, as described above, the AP may switch to a different frequency band (such as 5 GHz), remain at the particular frequency band and puncture the frequency band, or remain at the particular frequency band and reduce power.

After a certain time of operation and/or after the AP has traveled a certain distance (i.e., the location of the AP has changed by more than a threshold amount), the AP may return to block 410 to restart the process. For example, the AP may now be more than the threshold distance away from an incumbent and may return to preferred operations (e.g., standard power at the particular frequency band). On the other hand, the AP may switch frequency bands, reduce power, and/or puncture the frequency band if it is now less than a threshold distance from an incumbent. The certain time of operation and/or the certain distance may be based on a relative vicinity of the AP (such as a location in open waters), as well as the speed and/or path of the AP's travel (e.g., a ship is traveling slowly and/or circling rather than moving quickly to a destination). In this way, the AP is continuously maximizing operations at a desired frequency band while avoiding interference with incumbents.

In some embodiments, such as when the AP determines its future coordinates and/or the coordinates of one or more incumbents based on route data, the AP may automatically adjust operations as it travels since it knows in advance where and when it will encounter incumbents. Based on the coordinates and associated timestamps, the AP may switch between frequency bands, power modes, and/or the like as it nears and recedes from incumbents. Here too, the AP is able to optimize its preferred operations without causing interference. The AP may also be able to make real-time adjustments based on one more of the above methods if it encounters any unknown incumbents and/or deviates from its projected course.

In other embodiments, the threshold distance may be substituted with a threshold power value. For example, rather than adjusting operations based a distance from an incumbent, the AP may make adjustments based on a signal strength of the incumbent (e.g., the AP may increase power back to standard power as the signal strength from an incumbent falls below a threshold).

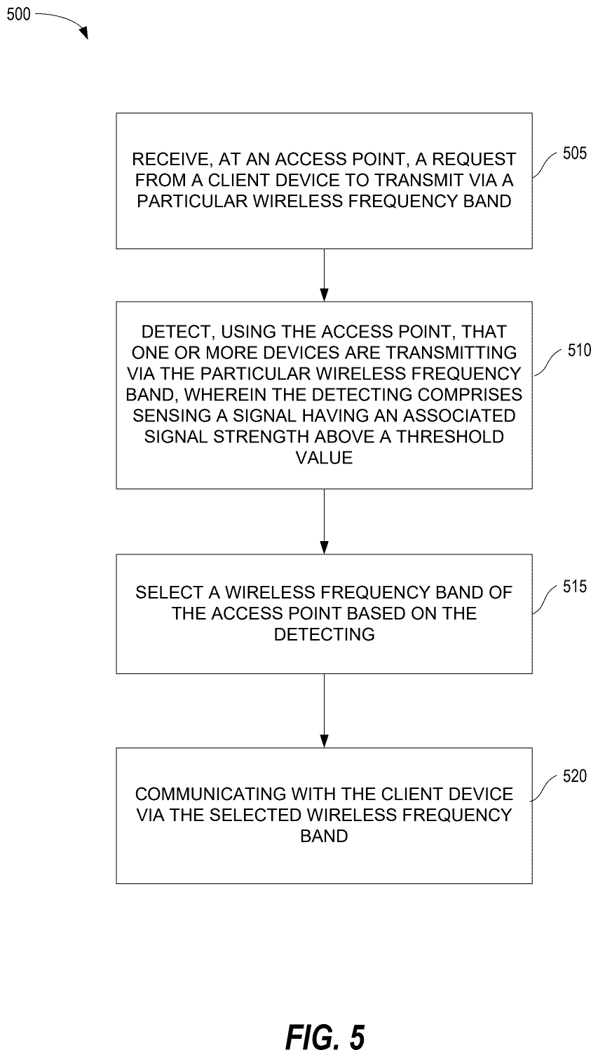

FIG. 5 is a flow diagram depicting an example method 500 for expanding transmission capabilities across frequency bands, according to some embodiments of the present disclosure.

At block 505, an AP (e.g., AP 110 of FIG. 1 or AP 210 of FIG. 2), receives a request from a client device (e.g., STA 105-1 in FIG. 1 or STA 205 of FIG. 2) to transmit via a particular wireless frequency band (e.g., the STA may be a smartphone attempting to connect to Wi-Fi services provided by the AP). In some embodiments, the particular wireless frequency band may comprise a 6 GHz frequency band.

At block 510, the AP detects that one or more devices are transmitting via the particular wireless frequency band as discussed at block 310 of FIG. 3. In some embodiments, the AP detects the one or more devices (i.e., incumbents) by scanning for signals with a signal strength above a threshold value (e.g., utilizing CCA). The AP may perform the detecting intermittently, such as based on a change in a location of the access point exceeding a certain distance or a specified amount of time. In this way, the AP is continuously able to account for incumbents entering and leaving the particular frequency band. In other embodiments, AP may perform the detecting by classifying incumbent waveforms on the particular frequency band (e.g., through an AFC system) based on characteristics, such as known signatures.

At block 515, the AP selects a wireless frequency band on which to operate of the access point based on any detected incumbents (i.e., to avoid interfering with the incumbents) as discussed at block 320 of FIG. 3. In some embodiments, the AP may select a wireless frequency band different than the particular wireless frequency band (e.g., transmitting via a 5 GHz frequency band rather than a 6 GHz frequency band). In other embodiments, the AP may transmit via the particular frequency band but on a subset of the particular wireless frequency band (e.g., though puncturing). In some other embodiments, the AP may transmit via the particular frequency band but at a reduced power level of the access point. In each case, the AP avoids interfering with incumbents on the particular frequency band (or portion thereof). The AP may also select the frequency band based on a distance between the location of the access point and one or more reference locations (e.g., switch frequency bands and/or power levels once an incumbent is no longer nearby), as discussed in FIG. 4.

At block 520, the AP communicates with the client device via the selected wireless frequency band (e.g., begins providing Wi-Fi) as discussed at block 335 of FIG. 3. The AP may continue to communicate accordingly until a certain time has passed or the AP, if mobile, has traveled a certain distance. The AP may then repeat one or more of the above steps depicted with respect to FIGS. 3 and/or 4 to determine if any incumbents remain or are newly operating on the particular wireless frequency band and may adjust its operations, such as by selecting a new wireless frequency band, reducing or increasing power, and/or the like.

In some embodiments, the AP may predict, using future trip data, locations of the one or more devices transmitting via the particular wireless frequency band and adjust the wireless frequency band of the access point based on the predicting, as discussed in FIG. 4. For example, the AP may determine ahead of time where and when it may encounter incumbents and automatically adjust settings (e.g., a frequency band, power level, etc.) once it reaches that time and/or place.

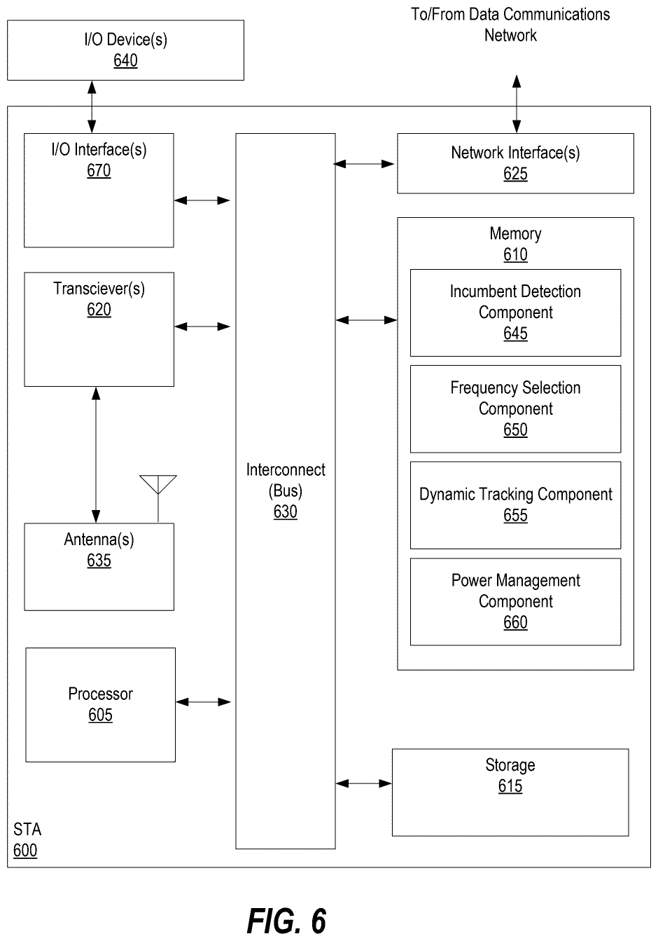

FIG. 6 depicts an example network device 600 configured to perform various aspects of the present disclosure. In some embodiments, the example network device 600 may be an AP or an STA, and communicate with and/or provide support for an associated STA (e.g., which is a device that operates multiple wireless technologies on shared hardware).

As illustrated, the example network device 600 includes a processor 605, memory 610, storage 615, one or more transceivers 620, one or more I/O interfaces 670, and one or more network interfaces 625. In some embodiments, I/O devices 640 are connected via the I/O interface(s) 670. Further, via the network interface 625, the network device 600 can be communicatively coupled with one or more other devices and components (e.g., via a network, which may include the Internet, local network(s), and the like). Each of the components is communicatively coupled by one or more buses 630. In some embodiments, one or more antennas 635 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 670, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for the efficient functioning of the system.

The memory 610 may include random access memory (RAM) and read-only memory (ROM). The memory 610 may store processor-executable software code containing instructions that, when executed by the processor 605, enable the network device 600 to perform various functions described herein for wireless communication. In the illustrated example, the memory 610 includes four software components: the incumbent detection component 645, the frequency selection component 650, the dynamic tracking component 655, and the power management component 660.

In one embodiment, the incumbent detection component 645 may detect one or more incumbents operating on a particular frequency band and/or what portion of the frequency band the one or more incumbents are operating. The incumbent detection component 645 may utilize CCA sensing, automatic frequency coordination, location-based scanning, or a combination thereof.

In one embodiment, the frequency selection component 650 may determine a frequency band with which to operate and/or a subset of a frequency band in which to operate based on information received from the incumbent detection component 645.

In one embodiment, the dynamic tracking component 655 may detect a location or a plurality of locations of the AP, store the detected location(s), and/or store the location(s) of one or more refence points. The dynamic tracking component 655 may also calculate distances between one or more stored locations and/or compare those distances to a set of threshold values.

In one embodiment, the power management component 660 may control power levels of the AP based on information from one or more other components with respect to FIG. 6 and/or based on power levels from non-associated devices and/or APs.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, at an access point, a request from a client device to transmit via a particular wireless frequency band;
detecting, using the access point, that one or more devices are transmitting via the particular wireless frequency band, wherein the detecting comprises sensing a signal having an associated signal strength above a threshold value;
selecting a wireless frequency band of the access point based on the detecting to avoid interfering with the one or more devices; and
communicating with the client device via the selected wireless frequency band.

2. The method of claim 1, wherein the particular wireless frequency band comprises a 6 GHz frequency band.

3. The method of claim 1, wherein the detecting, using the access point, that the one or more devices are transmitting via the particular wireless frequency band is performed intermittently based on one or more of:
a change in a location of the access point exceeding a threshold distance; or
a specified amount of time.

4. The method of claim 1, wherein the selecting the wireless frequency band of the access point based on the detecting comprises one or more of:
not transmitting via a wireless frequency band matching the particular wireless frequency band detected;
not transmitting on a subset of a spectrum over which the particular wireless frequency band is transmitting; or
reducing a transmission power of the access point.

5. The method of claim 1, wherein the selecting the wireless frequency band of the access point is further based on a distance between a location of the access point and one or more reference locations.

6. The method of claim 1, wherein the detecting, using the access point, that the one or more devices are transmitting via the particular wireless frequency band further comprises receiving one or more incumbent waveforms and classifying each incumbent waveform based on characteristics associated with the one or more incumbent waveforms.

7. The method of claim 1, further comprising predicting, using future trip data, locations of the one or more devices transmitting via the particular wireless frequency band and adjusting the wireless frequency band of the access point based on the predicting.

8. The method of claim 1, wherein the access point is mounted on a vehicle.

9. A system, comprising:
one or more processors; and
one or more memories storing a program, which, when executed on any combination of the one or more processors, performs operations, the operations comprising:
receiving, at an access point, a request from a client device to transmit via a particular wireless frequency band;
detecting, using the access point, that one or more devices are transmitting via the particular wireless frequency band, wherein the detecting comprises sensing a signal having an associated signal strength above a threshold value;
selecting a wireless frequency band of the access point based on the detecting to avoid interfering with the one or more devices; and
communicating with the client device via the selected wireless frequency band.

10. The system of claim 9, wherein the particular wireless frequency band comprises a 6 GHz frequency band.

11. The system of claim 9, wherein the detecting, using the access point, that the one or more devices are transmitting via the particular wireless frequency band is performed intermittently based on one or more of:
a change in a location of the access point exceeding a threshold distance; or
a specified amount of time.

12. The system of claim 9, wherein the selecting the wireless frequency band of the access point based on the detecting comprises one or more of:
not transmitting via a wireless frequency band matching the particular wireless frequency band detected;
not transmitting on a subset of a spectrum over which the particular wireless frequency band is transmitting; or
reducing a transmission power of the access point.

13. The system of claim 9, wherein the selecting the wireless frequency band of the access point is further based on a distance between a location of the access point and one or more reference locations.

14. The system of claim 9, wherein the detecting, using the access point, that the one or more devices are transmitting via the particular wireless frequency band further comprises receiving one or more incumbent waveforms and classifying each incumbent waveform based on characteristics associated with the one or more incumbent waveforms.

15. The system of claim 9, further comprising predicting, using future trip data, locations of the one or more devices transmitting via the particular wireless frequency band and adjusting the wireless frequency band of the access point based on the predicting.

16. A non-transitory computer-readable medium containing computer program code that, when executed by operation of one or more computer processors, performs operations comprising:
receiving, at an access point, a request from a client device to transmit via a particular wireless frequency band;
detecting, using the access point, that one or more devices are transmitting via the particular wireless frequency band, wherein the detecting comprises sensing a signal having an associated signal strength above a threshold value;
selecting a wireless frequency band of the access point based on the detecting to avoid interfering with the one or more devices; and
communicating with the client device via the selected wireless frequency band.

17. The non-transitory computer-readable medium of claim 16, wherein the particular wireless frequency band comprises a 6 GHz frequency band.

18. The non-transitory computer-readable medium of claim 16, wherein the detecting, using the access point, that the one or more devices are transmitting via the particular wireless frequency band is performed intermittently based on one or more of:
a change in a location of the access point exceeding a threshold distance; or
a specified amount of time.

19. The non-transitory computer-readable medium of claim 16, the selecting the wireless frequency band of the access point based on the detecting comprises one or more of:
not transmitting via a wireless frequency band matching the particular wireless frequency band detected;
not transmitting on a subset of a spectrum over which the particular wireless frequency band is transmitting; or
reducing a transmission power of the access point.

20. The non-transitory computer-readable medium of claim 16, wherein the selecting the wireless frequency band of the access point is further based on a distance between a location of the access point and one or more reference locations.
